(19) United States
(12) Patent Application Publication
(10) Pub. No.: US 2019/0217901 A1
(43) Pub. Date: Jul. 18, 2019

(54) SYSTEM FOR SOLAR HEATING MITIGATION

(71) Applicant: CORNING INCORPORATED, CORNING, NY (US)

(72) Inventors: Nicholas Francis Borrelli, Elmira, NY (US); Gregory Lee Bucher, Savona, NY (US); Wageesha Senaratne, Horseheads, NY (US); Sergey Yurevich Ten, Corning, NY (US)

(21) Appl. No.: 16/257,850

(22) Filed: Jan. 25, 2019

Related U.S. Application Data
(63) Continuation of application No. PCT/US19/13055, filed on Jan. 10, 2019.
(60) Provisional application No. 62/616,561, filed on Jan. 12, 2018.

(51) Int. Cl. B62D 25/06; B60R 13/08; B60R 13/02

(52) U.S. Cl. CPC B62D 25/06; B60R 13/0212; B60R 13/0869

(57) ABSTRACT

The roof of a vehicle includes a passive cooling layer overlaying an outward facing surface of the roof such that the layer is exposed to sunlight exterior to the vehicle. The layer includes a polymer having molecular structures with Si—O—Si linkages. The layer has relatively high emittance over a peak spectrum for solar heating.

### CROSS-REFERENCE TO RELATED APPLICATIONS

This application is a continuation of International Patent Application Serial No. PCT/US19/13055 filed on Jan. 10, 2019, which of claims the benefit of priority of U.S. Provisional Application Ser. No. 62/616,561 filed on Jan. 12, 2018 the contents of which are relied upon and incorporated herein by reference in their entirety as if fully set forth below.

### BACKGROUND

Vehicles exposed to sunlight typically heat up, which may be undesirable, such as when raising temperatures within the vehicle or causing stress within the body of the vehicle due to thermal expansion. A need exists for an efficient system to mitigate solar heating.

### SUMMARY

Applicants find that certain molecular structures, as disclosed herein, mitigate solar heating by avoiding or dissipating heat energy in a passive manner, without electromotive force. If a layer (e.g., film, thin film coating) with the molecular structures is applied with sufficient thickness and concentration, the layer may facilitate high emissivity of heat energy. Further, Applicants discovered that the molecular structures may be present in a polymeric material, which may be particularly efficient to coat vehicles and other structures for passive cooling.

Aspects of the present disclosure relate generally to a vehicle with solar heating mitigation. The vehicle has a body having a roof, wherein at least a portion of the roof is opaque to sunlight in the visible range. The vehicle also includes a passive cooling layer overlaying that portion of the roof on an outward facing surface of the roof such that the layer is exposed to light exterior to the vehicle. The layer includes (e.g., is formed from, is, is mostly) a polymer that has molecular structures with silicon-oxygen-silicon (Si—O—Si) linkages (e.g., bonds within a molecule, atomic bonds, covalent bonds), which Applicants believe facilitate a radiative cooling effect. The layer has a thickness and concentration of Si—O—Si linkages such that absorption of light at 10 μm wavelength by the layer is greater than 80%.

Other aspects of the present disclosure relate generally to a vehicle with solar heating mitigation, where the vehicle has a body having a roof and further includes a passive cooling layer overlaying an outward facing surface of the roof such that the layer is exposed to light exterior to the vehicle. The layer includes a polymer having molecular structures with Si—O—Si linkages. More specifically, the polymer is of the general formula [RSiO_{3/2}]ₙ, where n represents an integer and R represents hydrogen (H) and/or an organic group bonded to the Si—O—Si linkages. The R in at least some of the polymer is the organic group, and the organic group is bonded to the Si—O—Si linkages through a carbon-silicon bond.

Still other aspects of the present disclosure relate generally to a method of manufacturing a vehicle with solar heating mitigation. The method includes a step of coating a roof of the vehicle with a passive cooling layer. The layer includes a polymer having molecular structures with Si—O—Si linkages. Further, the polymer may be of the general formula [RSiO_{3/2}]ₙ.

Additional features and advantages are set forth in the Detailed Description that follows, and in part will be readily apparent to those skilled in the art from the description or recognized by practicing the embodiments as described in the written description and claims hereof, as well as the appended drawings. For example, other aspects of the present disclosure relate to an article, other than a vehicle, with a passive cooling layer, as described herein. Still other aspects of the present disclosure relate to a method of manufacturing such articles. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings of the Figures illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is perspective view from above of a vehicle with a roof according to an exemplary embodiment.

FIG. 2 is a conceptual diagram in cross-section of a portion of the roof of FIG. 1.

FIG. 3 is a plot of percent emittance versus wavelength for a material according to an exemplary embodiment.

FIG. 4 is a plot of percent reflectance versus wavelength for materials according to an exemplary embodiment.

FIG. 5 is a digital image of a polymer film according to an exemplary embodiment.

FIG. 6 is a plot of transmission of light through the film of FIG. 5.

### DETAILED DESCRIPTION

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

In view of the spectral distribution of energy of a black body, Applicants believe that peak energy flux occurs at 2400 to 3600 μm·K, the product of absolute temperature and wavelength of light. For a room temperature of approximately 300 K, Applicants believe that peak energy occurs at about 8 to 12 μm wavelength. Accordingly, cooling a body passively via radiation may benefit from material that has a high emissivity in that wavelength region because emissivity is related to the absorption. Applicants find that silica absorbs strongly in that wavelength region. However, silica has relatively high reflectivity at 10 μm, about 30%.

Diluting silica in a polymer circumvents the high reflectivity by changing the effective index of the silica/polymer composite. Further, Applicants believe that dispersion in optical constants that produces strong reflection of silica in turn produces a phenomenon at the interface of the silica with the polymer called the Fröhlich effect, a resonance phenomenon that increases absorption. Accordingly, this composite, including silica, is highly emissive and can be used for passive cooling, where the silica strongly absorbs light in the 8-12 μm wavelength region and this absorption leads to high emissivity in that region, a desirable spectral position for radiative cooling.

Surprisingly, Applicants have discovered that a polymer alone can benefit from the above-described radiative cooling effect. Some silicate materials of the general formula [RSiO_{3/2}]ₙ, where n is an integer and R is H or an organic group bonded to silica, may be a polymer. Such polymers include Si—O—Si linkages in the network intertwined with Si—R, and Applicants have found that the Si—O—Si linkages are sufficiently silica-like structures to benefit from the above-described radiative cooling effect. More specifically, Applicants believe that 9 μm absorption in the silica network originates from the anti-symmetric stretching of this Si—O—Si bond and thus the polymeric network containing these structures exhibits a strong absorption feature in the same spectral range as silica and may retain the low reflectivity associated with other polymers, resulting in relatively high emissivity in the 8-12 μm region, compared to bulk silica, silicon, or other materials.

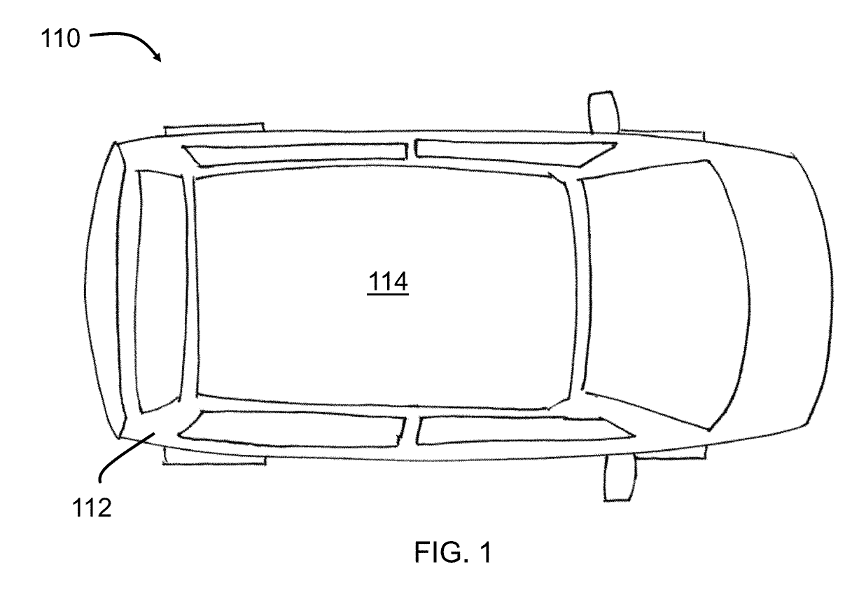

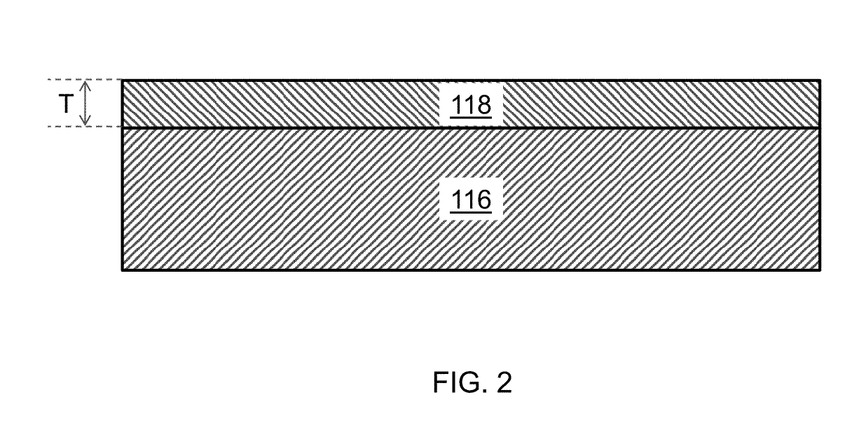

Referring to FIGS. 1-2, a vehicle 110 (e.g., car, truck, boat, plane, trailer) has solar heating mitigation, which includes a body 112 (e.g., cab, cabin, housing, enclosure) of the vehicle having a structure (e.g., wall, ceiling, covering) in the form of a roof 114. According to an exemplary embodiment, the roof 114 is at least in part formed from a metal 116 or other structural material (e.g., plaster, shingles, composite fiber) that is generally opaque to sunlight in the visible range. In some embodiments, the vehicle 110 further includes a passive cooling layer 118 (e.g., radiative cooling layer, heat energy dissipation layer), which cools the vehicle 110 without electromotive force. The layer 118 may be overlaying (e.g., indirectly covering with intermediate layer(s), directly bonded to, covering at least most of) the metal 116 on an outward facing surface of the roof 114 in FIG. 1 and/or other surfaces of the vehicle 110 such that the layer 118 is exposed to light (e.g., sunlight) exterior to the vehicle 110, such as directly exposed or exposed through a translucent layer(s) overlaying the layer 118.

According to an exemplary embodiment, the layer 118 includes (e.g., is, is mostly, is essentially) a silicate material such that the material contains anionic silica compounds or groups within compounds. In some embodiments, the layer 118 includes molecular structures, as discussed above, with Si—O—Si linkages, which may absorb light in the 8-12 μm wavelength region. For example, in some embodiments, the layer 118 has a thickness T and concentration of Si—O—Si linkages such that absorption of light at 10 μm wavelength by the layer 118 is greater than 50%, such as greater than 80%, such as greater than 90%, such as greater than 95%, such as greater than 99%. Because emissivity is related to absorption, Applicants believe the layer 118 provides passive cooling to the underlying body 112.

Materials having Si—O—Si linkages (e.g., silica, silicate materials) may include additional molecular compounds or groups that reduce or control reflectivity of the materials, as described above. Further, Applicants discovered certain polymer compounds that do not require addition of silica or other silicate materials in composite. Instead these polymers themselves have Si—O—Si linkages and relatively low reflectivity and may provide benefits of passive cooling without reliance on the Frölich effect, for example. Put another way, embodiments disclosed herein include single polymers that provide the benefits of low reflectivity and high emissivity without need of combining, mixing, dispersing, etc. combinations of materials. Furthermore, these polymers can be spray coated and cured thermally, with UV light, or otherwise, making such polymers particularly efficient and convenient for use in manufacturing and elsewhere.

In some embodiments, the material of the layer 118 is or includes an organic component, such as being an organometallic material, having a chemical bond between carbon of an organic compound and a metal, where an organic compound or group (e.g., alkyl, aryl, alkoxyl) is typically found in or made from living systems and is a chemical compound with one or more carbon atoms covalently linked to atoms of other elements, such as hydrogen, oxygen, or nitrogen. In some such embodiments, the material of the layer 118 is or includes an organosilicon material, having a chemical bond between carbon of an organic compound and silicon. According to an exemplary embodiment, the material of the layer 118 includes Si—O—Si linkages, such as may be present in silica or silicate materials, where the linkages may form rings of Si—O—Si linkages, cage structures of Si—O—Si linkages, ladder structures of Si—O—Si linkages, or more random configurations with Si—O—Si linkages.

For example, in some embodiments, the material of the layer 118 is or includes a silicate material and an organosilicon material of the general formula [RSiO_{3/2}]ₙ, where n represents an integer and R represents H and/or an organic group bonded to the Si—O—Si linkages, such as where the Si—O—Si has a cage, random, ladder or partial cage structure. In some such embodiments, the R is or includes the organic group, and the organic group is bonded to Si—O—Si linkages through a carbon-silicon bond. Examples of some such organosilicon materials may include silsesquioxane, polyoctahedral silsesquioxane, polydecahedral silsesquioxane, polydodecahedral silsesquioxane, cubic silsesquioxane, imine-silsesquioxane, polymeric silsesquioxane, hydridosilsesquioxane, organosilsesquioxane, poly(methylsilsesquioxane), poly(phenylsilsesquioxane), poly(hydridosilsesquioxane), methylsilsesquioxane, polyhedral oligomeric silsesquioxane, and others. In some embodiments, the material of the layer 118 is or includes a polymer (i.e. molecule with chains of repeating subunits), such as a polymer of the general formula [RSiO_{3/2}]ₙ, as described herein.

Applicants tested various compositions in accordance with the present disclosure. For example, Si and C weight percentage (wt %) for each polymer in the table below was determined using standard inductively-coupled plasma optical emission spectrometry (ICP/OES) analytical testing for silicon and standard instrumental gas analysis (IGA) analytical testing for carbon.

| | | C | |
|---|---|---|---|
| | Si | (wt | |
| Description | (wt %) | %) | C/Si |
| methacrylate functionalized polyoctahedral | 15.1 | 44 | 2.9 |
| silsesquioxane | | | |
| methacrylate functionalized polyoctahedral | 23.2 | 33 | 1.4 |
| silsesquioxane with silica dispersion | | | |
| Phenylsilsesquioxane - dimethylsiloxane | 31 +/− 9 | 39 | 0.1-1.8 |
| Phenylsilsesquioxane - dimethylsiloxane | 28.5 +/− 3.6 | 35 | 1.1-1.4 |
| with 6% silica dispersion 1 | | | |
| Phenylsilsesquioxane - dimethylsiloxane | 29.7 +/− 1.7 | 35 | 1.1-1.2 |
| with 6% silica dispersion 2 | | | |

Such materials when used in the layer 118 may have sufficient concentrations of the Si—O—Si linkages to absorb sunlight and corresponding high emissivity as described herein. Concentration of Si—O—Si may be reduced if the thickness T is increased. In some embodiments, the layer has a thickness of at least 20 μm, such as at least 50 μm, such as at least 100 μm, such as at least 200 μm, and/or no more than 10 mm, such as no more than 5 mm, such as no more than 3 mm, such as no more than 1 mm, such as no more than 500 μm, such as no more than 200 μm. In at least some contemplated embodiments, the thickness T may be less than 20 μm or greater than 10 mm. In some embodiments, emittance is at least about 50%, such as at least 70%, such as at least 80%, such as at least about 90% for wavelengths in the 8 to 12 μm region, such as for most wavelengths therein, such as for at least 90% of wavelengths therein, such as for all wavelengths therein.

Polymers of the general formula [RSiO_{3/2}]ₙ that provide passive cooling, as disclosed herein, may be useful for the layer 118 because the polymers may be in liquid form and sprayed or otherwise relatively easily coated onto surfaces, such as the roof 114 of the vehicle 110. By spraying, Applicants mean that the liquid may be driven through a nozzle and formed into tiny particles or droplets (i.e. atomization), such as formed into a mist, and blown or otherwise driven through the air or another gas to the surface. Some such polymers may be thermally set or cured with UV light. For example, some manufacturing processes include heating such a coating to at least 100° C. to facilitate bonding of the layer 118 to underlying structure, such as metal 116 of the roof 114. Further, in contemplated embodiments, at least some of such polymers may be processed such that organic groups of the compounds may be burned off or otherwise removed, while leaving the Si—O—Si linkages, such as to decrease the thickness T of the layer 118 and increase concentration of the Si—O—Si linkages. Applicants believe passive cooling benefits may be retained by the layer 118 even if organic components of the layer 118 are removed or degrade in time.

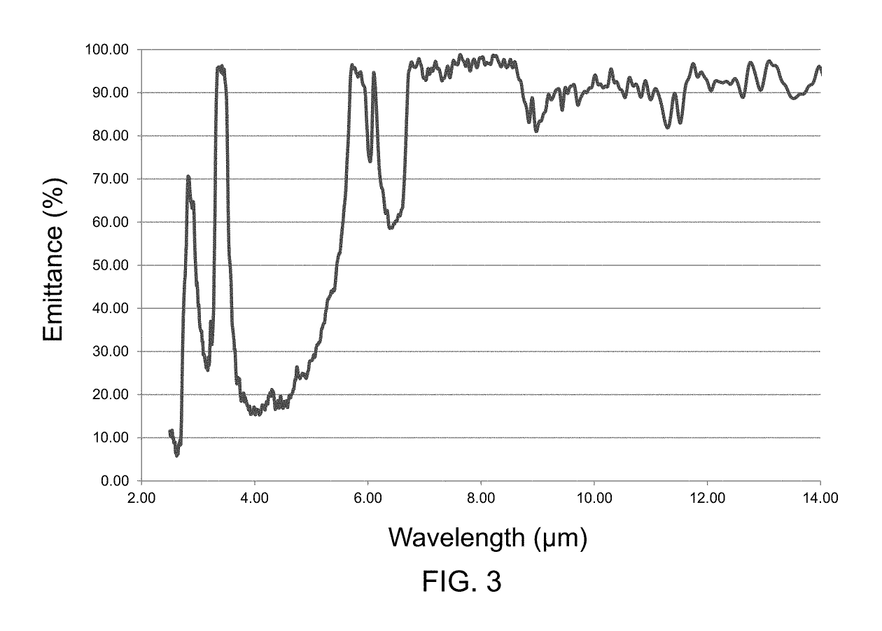

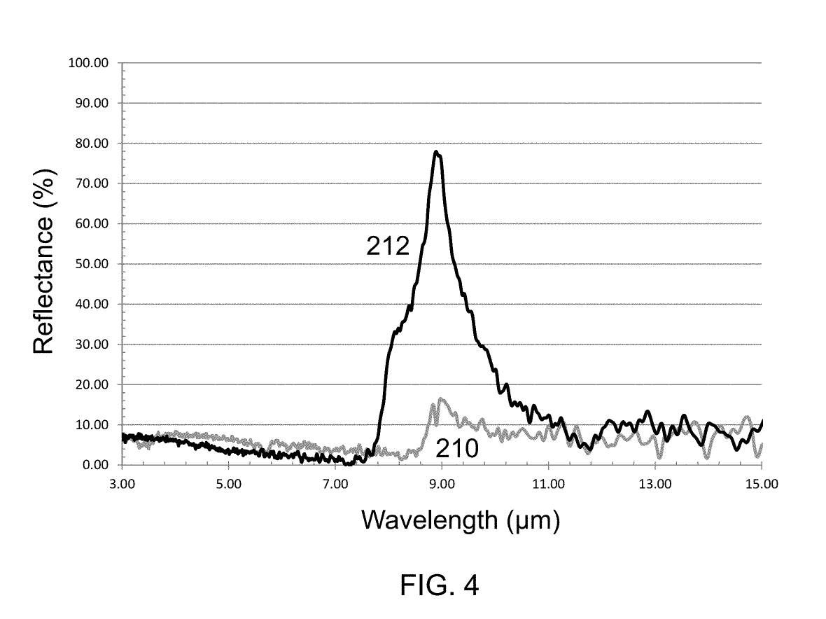

Applicants have found that the passive cooling benefits of organosilicon material of the general formula [RSiO_{3/2}]ₙ in a polymer form may be achieved without use of additional materials, such as index-matched polymer as may reduce reflectivity of silica, as discussed above. The high value of emittance that occurs with such polymers disclosed herein appears to stem from the polymer network of such material itself. For example, FIG. 3 shows emittance data for a 100 μm thick film of silsesquioxane. This benefit of polymers of the general formula [RSiO_{3/2}]ₙ, as disclosed herein, is further evidenced in FIG. 4, which compares reflection of methacryl-polyhedral oligomeric silsesquioxane 210 with that of bulk high purity fused silica 212 (without index-matched polymer matrix). As can be seen, Applicants found that reflection for the polymer with Si—O—Si linkages was on the order of five times less than bulk silica.

While FIG. 1 includes the vehicle 110, the layer 118 can be in the form of a film, such as thin film, which may be applied to a broad variety of surfaces to provide radiative cooling. For example, the layer may be bonded to metals, such as the metal of the roof 114, or silicon, or other substances. Some embodiments disclosed herein, such as liquid polymers that include Si—O—Si linkages may be sprayed onto surfaces and cured, such as by heat or light. Precursor materials for at least some such materials may be commercially available. In some such embodiments, the materials may be applied directly to the surface of an article, such as a vehicle, a roof, a structure, etc., and cured. Further, the material may be used to form layers similar to layer 118 on articles in manufacturing or on articles that are already manufactured and/or deployed, such as the roof of a building, water tanks, storage units, solar cells, equipment housings, etc., which may benefit from passive cooling.

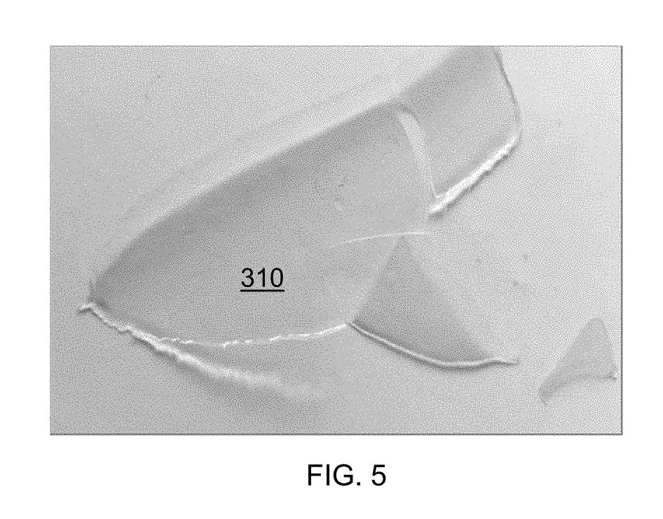

FIG. 5 shows a free-standing photopolymerized silsesquioxane polymer 310 having a thickness of 100 μm. To produce the film, Applicants added a photoinitiator to methacrylate (or acrylate) polyoctahedral silsesquioxane, where silsesquioxane has organic methacrylate groups at the corners of its [RSiO_{3/2}]ₙ molecular cage, and then Applicants photopolymerized this material to form crosslinked polysilsesquioxane, as shown in FIG. 5. Alternatively, such formulations may be mixed with solvents for application by spray, dip, aerosol jet, roller, blade coating or other methods, followed by ultra-violet or thermal cure.

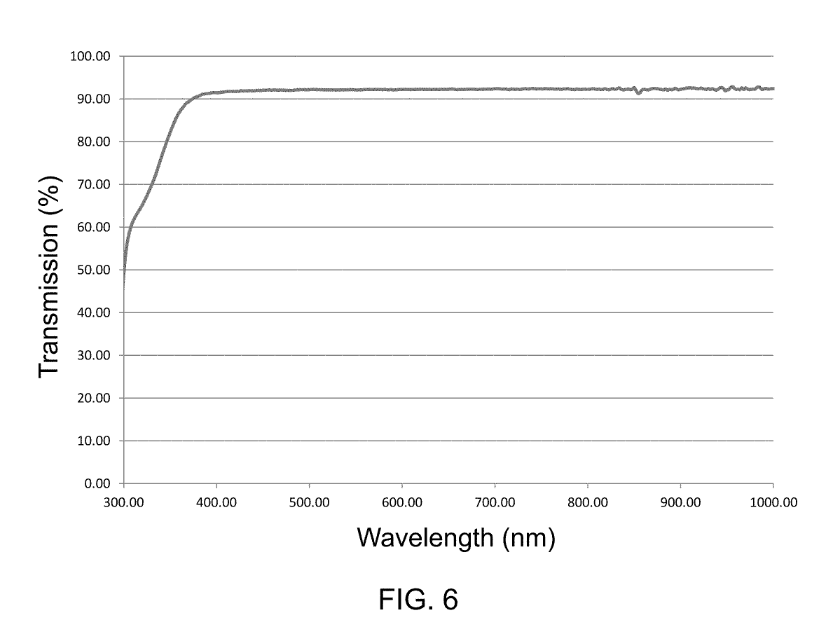

As can be seen in FIG. 5, the polymer film is relatively clear. FIG. 6 shows the percent transmission of light through the polymer film of FIG. 5 over a portion of the electromagnetic spectrum. Transmission of light through the film is at least 50%, such as at least 80%, such as at least 90% over at least some of the visible spectrum, such as over at least most of the visible spectrum, such as over at least most of the spectrum between 390 nm and 700 nm wavelengths, such as over all of the spectrum between 390 nm and 700 nm wavelengths.

Applicants tested similar thin coats for percent emittance of phenyl silsesquioxanedimethylsiloxane copolymer and found similar performance and advantages over high purity fused silica, where emittance was at least 80%, such as at least 85%, such as at least 90% for light in at least some of the range of 8 to 12 μm wavelength, such as at least most of the range of 8 to 12 μm wavelength, such as all of the range of 8 to 12 μm wavelength for the at least 80% and at least 85% emittance. Applicants additionally found, through empirical experimentation, that increasing thickness of the layer 118 greater than 100 μm increases emittance over at least some of the 8 to 12 μm wavelength range.

Accordingly, thin films of polymer having the Si—O—Si linkages, as disclosed herein, may be used with articles that may benefit from or require transmission of light through some or all the visible spectrum, such as windows (e.g., windshields, sunroofs), clear housings (e.g., greenhouses), photovoltaic cells, etc. Articles that include paint, writing, or other decorations may benefit from the passive cooling layer, as disclosed herein, overlaying the decorations, while still having the decorations be visible through the layer. In addition to vehicles, articles such as outdoor seating (e.g., stadium seating, park benches), hand rails, barefoot walkways, etc., that may become uncomfortable to users when exposed to excessive solar heating, but may also benefit from being coated with the passive cooling layer disclosed herein.

The construction and arrangements of the methods and products, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

What is claimed is:

1. A vehicle with solar heating mitigation, comprising:
a body having a roof, wherein at least a portion of the roof is opaque to sunlight in the visible range; and
a passive cooling layer overlaying the portion of the roof on an outward facing surface of the roof such that the layer is exposed to light exterior to the vehicle,
wherein layer comprises a polymer,
wherein the layer comprises molecular structures with Si—O—Si linkages, and
wherein the layer has a thickness and concentration of Si—O—Si linkages such that absorption of light at 10 μm wavelength by the layer is greater than 80%.

2. The vehicle of claim 1, wherein the portion of the roof that is opaque to sunlight comprises painted metal, wherein the layer overlays the painted metal, wherein transmission of light through the layer is as at least 80% over at least most of the spectrum between 390 nm and 700 nm wavelengths, whereby the painted metal is visible through the layer.

3. The vehicle of claim 1, wherein the polymer comprises molecular structures with Si—O—Si linkages and the polymer is of the general formula [RSiO_{3/2}]ₙ, where n represents an integer and R represents hydrogen and/or an organic group bonded to the Si—O—Si linkages.

4. The vehicle of claim 3, wherein the R in at least some of the polymer is the organic group, and the organic group is bonded to Si—O—Si linkages through a carbon-silicon bond.

5. The vehicle of claim 1, wherein the thickness of the passive cooling layer is at least 50 μm.

6. The vehicle of claim 5, wherein the thickness of the passive cooling layer is no more than 200 μm.

7. The vehicle of claim 6, wherein the thickness of the passive cooling layer and the concentration of Si—O—Si linkages is such that absorption of light at 10 μm wavelength by the layer is greater than 99%.

8. A vehicle with solar heating mitigation, comprising:
a body having a roof; and
a passive cooling layer overlaying an outward facing surface of the roof such that the layer is exposed to light exterior to the vehicle,
wherein layer comprises a polymer,
wherein the polymer comprises molecular structures with Si—O—Si linkages,
wherein the polymer is of the general formula [RSiO_{3/2}]ₙ, where n represents an integer and R represents hydrogen and/or an organic group bonded to the Si—O—Si linkages,
wherein the R in at least some of the polymer is the organic group, and the organic group is bonded to the Si—O—Si linkages through a carbon-silicon bond.

9. The vehicle of claim 8, wherein transmission of light through the layer is as at least 80% over at least most of the spectrum between 390 nm and 700 nm wavelengths.

10. The vehicle of claim 8, wherein thickness of the passive cooling layer is at least 50 μm and no more than 200 μm.

11. The vehicle of claim 8, wherein thickness of the passive cooling layer and concentration of the Si—O—Si linkages is such that absorption of light at 10 μm wavelength by the layer is greater than 99%.

12. A method of manufacturing a vehicle with solar heating mitigation, comprising:
coating a roof of the vehicle with a passive cooling layer,
wherein the layer comprises a polymer,
wherein the polymer comprises molecular structures with Si—O—Si linkages,
wherein the polymer is of the general formula [RSiO_{3/2}]ₙ, where n represents an integer and R represents hydrogen and/or an organic group bonded to the Si—O—Si linkages, and
wherein the R in at least some of the polymer is the organic group, and the organic group is bonded to the Si—O—Si linkages through a carbon-silicon bond.

13. The method of claim 12, further comprising, after the coating step, heating the polymer to at least 100° C. to facilitate bonding the layer to the roof.

14. The method of claim 13, wherein, during the heating step, at least some of the R that is the organic group is removed from the polymer while leaving corresponding Si—O—Si linkages bonded to the roof.

15. The method of claim 14, further comprising, after the heating step, cooling the layer to less than 50° C., wherein thickness of the layer after the cooling is at least 50 μm and no more than 200 μm.

16. The method of claim 14, wherein thickness of the passive cooling layer and the concentration of the Si—O—Si linkages is such that absorption of light at 10 μm wavelength by the layer is greater than 99%.

17. The method of claim 16, wherein the polymer is or is in a liquid prior to the coating step, and wherein the coating step comprises spraying the roof of the vehicle with the passive cooling layer.

18. An article, comprising:
an outward facing surface of the article,
a passive cooling layer overlaying the outward facing surface of the article such that the layer is exposed to light exterior to the article,
wherein the layer comprises a polymer,
wherein the polymer comprises molecular structures with Si—O—Si linkages,
wherein the polymer is of the general formula [RSiO_{3/2}]ₙ, where n represents an integer and R represents hydrogen and/or an organic group bonded to the Si—O—Si linkages,
wherein the R in at least some of the polymer is the organic group, and the organic group is bonded to the Si—O—Si linkages through a carbon-silicon bond, and
wherein the layer has a thickness on the outward facing surface and a concentration of Si—O—Si linkages such that absorption of light at 10 μm wavelength by the layer is greater than 80%.

19. The article of claim 18, wherein the thickness of the passive cooling layer is at least 50 μm and no more than 200 μm.

20. The article of claim 18, wherein the thickness of the passive cooling layer and the concentration of Si—O—Si linkages thereof is such that absorption of light at 10 μm wavelength by the layer is greater than 99%.
